(19) United States
(12) Patent Application Publication
(10) Pub. No.: US 2021/0003686 A1
(43) Pub. Date: Jan. 7, 2021

(54) DISTANCE MEASUREMENT DEVICE, DISTANCE MEASUREMENT SYSTEM, AND DISTANCE MEASUREMENT METHOD

(71) Applicant: NIPPON TELEGRAPH AND TELEPHONE CORPORATION, Tokyo (JP)

(72) Inventors: Shingo TSUKADA, Musashino-shi, Tokyo (JP); Hiroshi NAKASHIMA, Musashino-shi, Tokyo (JP); Tetsuomi SOGAWA, Musashino-shi, Tokyo (JP)

(73) Assignee: NIPPON TELEGRAPH AND TELEPHONE CORPORATION, Tokyo (JP)

(21) Appl. No.: 16/968,837

(22) PCT Filed: Feb. 13, 2019
(86) PCT No.: PCT/JP2019/005032

§ 371 Date: Aug. 10, 2020

(30) Foreign Application Priority Data
Feb. 13, 2018 (JP) 2018-023541

(51) Int. Cl. G01S 11/14; A63B 69/36; G01S 11/02

(52) U.S. Cl. CPC G01S 11/14; A63B 2220/20; G01S 11/02; A63B 69/36

(57) ABSTRACT

Provided is a distance measuring apparatus, including an information acquisition unit that acquires information output from a second device that is attached to a target site for which a distance between a reference site and the target site is to be measured and acquires sound wave or radio wave output from a first device that is attached to the reference site and outputs sound wave or radio wave and information relating to an output of a first device; and a distance acquisition unit that acquires a distance between the first device and the second device on the basis of the acquired information.

### TECHNICAL FIELD

The present invention relates to a distance measuring apparatus, a distance measuring system, and a distance measuring method.

### BACKGROUND ART

In various athletic sports such as golf, tennis, and baseball, a player makes a certain progress by acquiring postures and forms that are conceived to be the most reasonable through practice, for example. In particular, in golf, an accurate swing form is required to be acquired due to the nature of the sport in which the accuracy of the flying ball direction directly affects the score.

In the swing movement of golf, the swing and the form before and after an impact (the moment the club face surface hits the ball) are important in order for the player to accurately control the movement of the arms and to improve motion efficiency. As means for verifying the swing and the form before and after an impact, methods using an accelerometer, a strain meter, images, a GPS (Global Positioning System), and the like are known (for example, see NPL 1).

### CITATION LIST

### Non Patent Literature

[NPL 1] KazuakiKawashima, Gorufu Suingu no Dousa Bunseki to Gorufu Pureiyah no Shintai Tokusei ni Kansuru Kenkyu (Studies on Motion Analysis of Golf Swing and Physical Characteristics of Golf Player), Graduate School of WASEDA University, Doctoral dissertation (Graduate School of Human Sciences), January 2004.

### SUMMARY OF THE INVENTION

### Technical Problem

The accelerometer and the strain meter measure the absolute physical quantity in sections on which the measuring instruments are mounted. Therefore, it is difficult to compare and analyze the physical quantity of two or more sections that are important for the swinging movement of golf. With images, the differences in the physical quantity such as the distance and the movement speed of two or more sections to which markers are attached can be compared. However, when the markers are hidden due to the movement of the player, obstacles, and the like, the measurement cannot be performed. The measurement by GPS can only be performed under an environment in which communication with a GPS satellite can be performed, that is, an outside place with good visibility.

In the related-art methods described above, there has been a problem in that the distance between a plurality of sections during the movement of the player cannot be measured in a more convenient manner because the measurement cannot be performed depending on the movement of the player and obstacles, and the measuring environment is limited. Note that the problem as above is not limited to golf, and is a problem common to athletic sports in general.

In view of the abovementioned situation, an object of the present invention is to provide a feature capable of measuring the distance between a plurality of sections during the movement of a person to be measured in a more convenient manner.

### Means for Solving the Problem

According to one aspect of the present invention, provided is a distance measuring apparatus including: an information acquisition unit that is to be attached to a reference site, the information acquisition unit being configured to acquire sound wave or radio wave output from a first device that outputs sound wave or radio wave, information output from a second device that is attached to a target site for which a distance between the reference site and the target site is to be measured, and information relating to an output of a first device; and a distance acquisition unit that acquires a distance between the first device and the second device on the basis of the acquired information.

According to one aspect of the present invention, in the distance measuring apparatus, the information output from the second device is acquired sound wave information indicating the sound wave output from the first device, the information relating to the output of the first device is output sound wave information indicating the sound wave output from the first device, and the distance acquisition unit acquires the distance between the first device and the second device on the basis of the acquired sound wave information and the output sound wave information.

According to one aspect of the present invention, in the distance measuring apparatus, the distance acquisition unit acquires the distance between the first device and the second device on the basis of a phase difference between a waveform of sound indicated by the acquired sound wave information and a waveform of sound indicated by the output sound wave information.

According to one aspect of the present invention, in the distance measuring apparatus, the information output from the second device is acquisition time point information indicating a time point at which the radio wave output from the first device is acquired, the information relating to the output of the first device is output time point information indicating a time point at which the first device outputs the sound wave or the radio wave, and the distance acquisition unit acquires the distance between the first device and the second device on the basis of the acquisition time point information and the output time point information.

According to one aspect of the present invention, in the distance measuring apparatus, the distance acquisition unit acquires the distance between the first device and the second device on the basis of a time difference between a time point indicated by the acquisition time point information and a time point indicated by the output time point information.

According to one aspect of the present invention, there is provided a distance measuring system including: a first device that is attached to a reference site and outputs sound wave or radio wave; a second device that is attached to a target site for which a distance between the reference site and the target site is to be measured and acquires the sound wave or the radio wave output from the first device; an information acquisition unit that acquires information output from the second device and information relating to the output of the first device; and a distance acquisition unit that acquires a distance between the first device and the second device on the basis of the acquired information.

According to one aspect of the present invention, there is provided a distance measuring method including: an information acquisition step of acquiring information relating to an output of a first device, which is attached to a reference site and which outputs sound wave or radio wave, and information output from a second device, which acquires the sound wave or the radio wave output from the first device and is attached to a target site for which a distance between the reference site and the target site is to be measured; and a distance acquisition step of acquiring a distance between the first device and the second device on the basis of the acquired information.

### Effects of the Invention

According to the present invention, the distance between the plurality of sections during the movement of the person to be measured can be measured in a more convenient manner.

### BRIEF DESCRIPTION OF DRAWINGS

FIG. 1 is a configuration view illustrating a system configuration of a distance measuring system in the present invention.

FIG. 2 is a schematic block diagram illustrating a function configuration of a distance measuring apparatus in Embodiment 1.

FIG. 3 is a sequence diagram illustrating the flow of processing of the distance measuring system in Embodiment 1.

FIG. 4 is a schematic block diagram illustrating a function configuration of a distance measuring apparatus in Embodiment 2.

FIG. 5 is a sequence diagram illustrating the flow of processing of a distance measuring system in Embodiment 2.

### DESCRIPTION OF EMBODIMENTS

One embodiment of the present invention is described below with reference to the drawings.

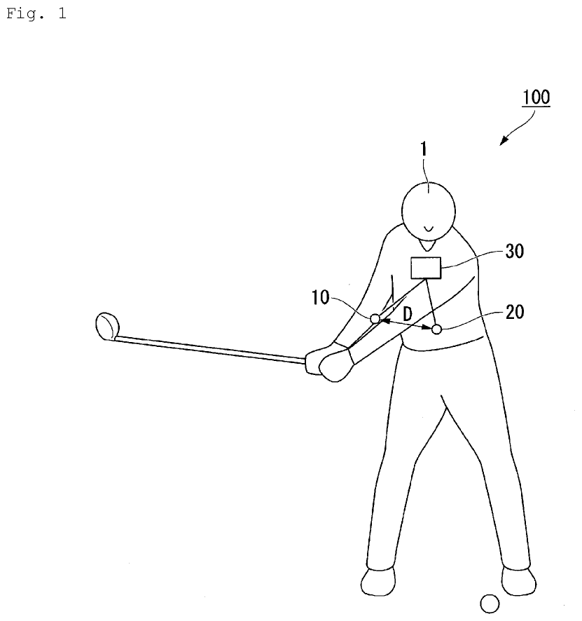

FIG. 1 is a configuration view illustrating a system configuration of a distance measuring system 100 in the present invention.

The distance measuring system 100 includes a first device 10, a second device 20, and a distance measuring apparatus 30. The first device 10 and the distance measuring apparatus 30, and the second device 20 and the distance measuring apparatus 30 may be connected to each other in a wired or wireless manner.

Note that, in the description below, golf is described as an example of an athletic sport to which the distance measuring system 100 is applied, but the distance measuring system 100 is not limited to being applied to golf, and can be applied to various athletic sports in general such as tennis and baseball.

The first device 10, the second device 20, and the distance measuring apparatus 30 are attached to the body of a person 1 to be measured. Specifically, the first device 10 and the second device 20 are attached to sections with which the distance between two spots is to be measured. For example, the first device 10 is attached to the reference site, and the second device 20 is attached to a target site for which a distance between the reference site and the target site is to be measured.

In the example illustrated in FIG. 1, an example in which the first device 10 is attached to the right elbow and the second device 20 is attached to the trunk (abdominal region) is illustrated. The distance measuring apparatus 30 may be attached to any section of the body of the person 1 to be measured, or does not necessarily need to be attached to the body of the person 1 to be measured as long as the distance measuring apparatus 30 can be connected to the first device 10 and the second device 20.

The first device 10 outputs sound wave or radio wave. For example, the first device 10 is a speaker or a transmitter.

The sound wave or the radio wave output from the first device 10 is input to the second device 20. For example, the second device 20 is a microphone or a receiver.

The distance measuring apparatus 30 acquires information on the distance between the first device 10 and the second device 20 on the basis of the sound wave or the radio wave input to the second device 20. For example, the distance measuring apparatus 30 acquires the information on the distance by measuring the distance between the first device 10 and the second device 20 on the basis of the sound wave or the radio wave input to the second device 20.

Specific configuration examples (Embodiment 1 and Embodiment 2) of the distance measuring system 100 in the present invention are described below.

### Embodiment 1

In Embodiment 1, a case where the first device 10 is a speaker and the second device 20 is a microphone is described. In the case of Embodiment 1, the speaker outputs sound, and the microphone collects the sound.

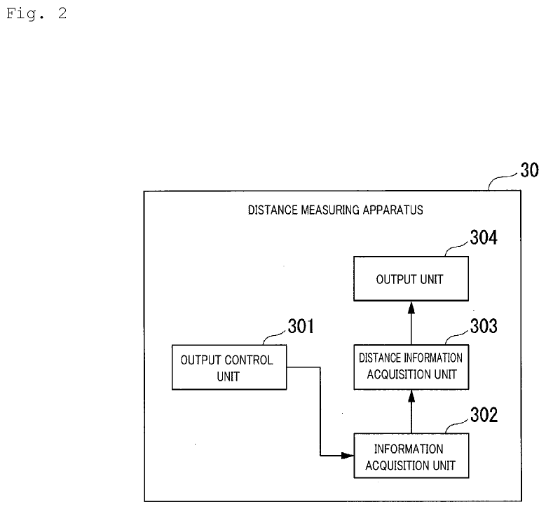

FIG. 2 is a schematic block diagram illustrating a function configuration of the distance measuring apparatus 30 in Embodiment 1.

The distance measuring apparatus 30 includes a CPU (Central Processing Unit), a memory, an auxiliary storage apparatus, and the like connected to each other by a bus, and executes a distance measuring program. By executing the distance measuring program, the distance measuring apparatus 30 functions as an apparatus including an output control unit 301, an information acquisition unit 302, a distance information acquisition unit 303, and an output unit 304. Note that all or some of the functions of the distance measuring apparatus 30 maybe implemented with use of hardware such as an ASIC (Application Specific Integrated Circuit), a PLD (Programmable Logic Device), and an FPGA (Field Programmable Gate Array). The distance measuring program may be recorded on a computer readable recording medium. The computer readable recording medium is a portable medium such as a flexible disk, a magneto-optical disk, a ROM, and a CD-ROM, or a storage apparatus such as a hard disk drive built in a computer system, for example. The distance measuring program may be transmitted and received via an electric telecommunication line.

The output control unit 301 controls the output timing of the speaker. Specifically, the output control unit 301 generates sound to be output for the speaker, and controls the output timing of the speaker by causing the speaker to output the generated sound. The output control unit 301 outputs information on the generated sound to the distance information acquisition unit 303.

The information acquisition unit 302 acquires information on the sound wave collected by the microphone.

The distance information acquisition unit 303 acquires the distance between the speaker and the microphone on the basis of the information on the sound wave acquired by the information acquisition unit 302 and the information on the sound output from the output control unit 301.

The output unit 304 outputs the measurement result acquired by the distance information acquisition unit 303.

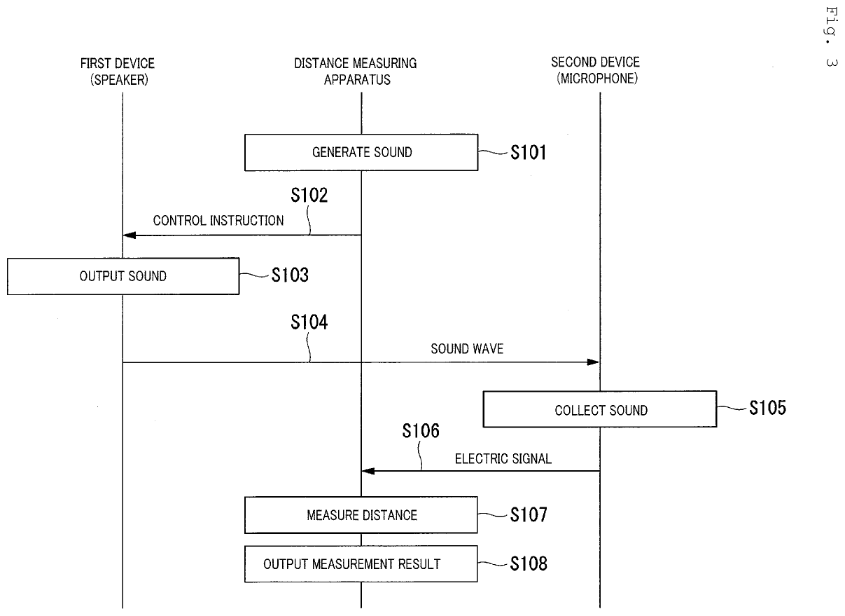

FIG. 3 is a sequence diagram illustrating the flow of processing of the distance measuring system 100 in Embodiment 1.

The output control unit 301 generates sound at a first timing (Step S101). The first timing may be a timing at which an instruction for generating sound is provided from the outside, a timing at which a predetermined period of time passes after the start up, or other timings. The output control unit 301 outputs a control instruction including an instruction for outputting the generated sound to the speaker (Step S102).

The speaker acquires the control instruction output from the distance measuring apparatus 30. The speaker outputs sound in accordance with the acquired control instruction (Step S103). For example, the speaker outputs pulsed or sinusoidal waves sound.

The sound output from the speaker is propagated through the air as the sound wave (Step S104).

The microphone collects the sound (Step S105). The microphone converts the information on the collected sound wave to electric signals and outputs the electric signals to the distance measuring apparatus 30 (Step S106).

The information acquisition unit 302 acquires the electric signals output from the microphone. The information acquisition unit 302 outputs the acquired electric signals to the distance information acquisition unit 303. The distance information acquisition unit 303 measures the distance on the basis of the phase shift between the waveform of the sound generated in the processing in Step S101 and the waveform of the electric signals output from the information acquisition unit 302 (Step S107). Specifically, first, the distance information acquisition unit 303 calculates a shift Δt of the phase such as a peak of the sound with use of the waveform of the sound generated in the processing in Step 5101 and the waveform of the electric signals output from the information acquisition unit 302. Next, the distance information acquisition unit 303 calculates a sound velocity v(T) at a certain temperature T. Then, when the distance between the two spots is represented by D1, the distance information acquisition unit 303 measures a distance D1 between the speaker and the microphone on the basis of Formula 1 below.

[Formula. 1]

D1=v(T)×vt Formula 1

The distance information acquisition unit 303 outputs information on the distance Dl between the speaker and the microphone that is the calculation result to the output unit 304. The output unit 304 outputs the information on the distance Dl to an external display apparatus (Step S108).

According to the distance measuring system 100 formed as above, the distance between the reference site and the section to be measured is calculated on the basis of the difference in the propagation time, and hence the distance between the plurality of sections during the movement of the person to be measured can be measured in a more convenient manner regardless of the measuring environment, the movement of the person to be measured, and obstacles.

### Modified Example

In this embodiment, a configuration in which the microphone is attached to one section has been described, but a configuration in which microphones are installed in a plurality of sections to be measured may be employed. When such configuration is employed, the distance information acquisition unit 303 determines information on the sound wave acquired from the microphones on the basis of identification information of the microphones, and measures the distances between the speaker and the microphones.

As a result, the distances between the reference site and the plurality of sections to be measured can be simultaneously measured.

For golf, the distance information acquisition unit 303 may be formed so as to measure the time point of the impact on the basis of the sound generated at the moment the club face surface hits the ball. Information on the sound generated at the moment the club face surface hits the ball may be stored in the distance information acquisition unit 303 in advance.

The distance information acquisition unit 303 may be formed so as to acquire the distance between the two spots on the basis of a table in which the shift Δt of the phase, the sound velocity v(T) at the certain temperature T, and the distance D1 between the two spots are associated with each other.

Some of the function units (the output control unit 301, the information acquisition unit 302, the distance information acquisition unit 303, and the output unit 304) included in the distance measuring apparatus 30 may be included in other apparatuses.

### Embodiment 2

In Embodiment 2, a case where the first device 10 is a transmitter and the second device 20 is a receiver is described. In the case of Embodiment 1, the transmitter transmits a packet, and the receiver receives the packet.

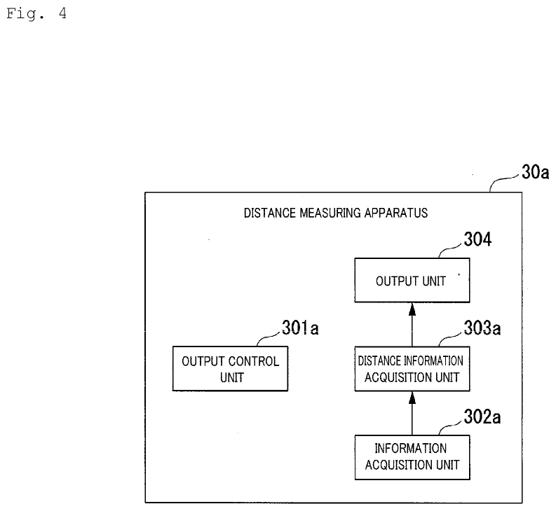

FIG. 4 is a schematic block diagram illustrating a function configuration of a distance measuring apparatus 30a in Embodiment 2.

The distance measuring apparatus 30a includes a CPU, a memory, an auxiliary storage apparatus, and the like connected to each other by a bus, and executes a distance measuring program. By executing the distance measuring program, the distance measuring apparatus 30a functions as an apparatus including an output control unit 301a, an information acquisition unit 302a, a distance information acquisition unit 303a, and an output unit 304. Note that all or some of the functions of the distance measuring apparatus 30a may be implemented with use of hardware such as an ASIC, a PLD, an FPGA. The distance measuring program may be recorded on a computer readable recording medium. The computer readable recording medium is a portable medium such as a flexible disk, a magneto-optical disk, a ROM, and a CD-ROM, or a storage apparatus such as a hard disk drive built in a computer system, for example. The distance measuring program may be transmitted and received via an electric telecommunication line.

The distance measuring apparatus 30a has a configuration different from that of the distance measuring apparatus 30 in that the output control unit 301a, the information acquisition unit 302a, and the distance information acquisition unit 303a are included in place of the output control unit 301, the information acquisition unit 302, and the distance information acquisition unit 303. The other configurations of the distance measuring apparatus 30a are similar to those of the distance measuring apparatus 30. Therefore, the description of the entire distance measuring apparatus 30a is omitted, and the output control unit 301a, the information acquisition unit 302a, and the distance information acquisition unit 303a are described.

The output control unit 301a controls the output timing of the transmitter. Specifically, the output control unit 301a controls the output timing of the transmitter by transmitting a packet to the transmitter that is a transmitter.

The information acquisition unit 302a acquires the packet received by the receiver.

The distance information acquisition unit 303a acquires the distance between the transmitter and the receiver on the basis of the packet acquired by the information acquisition unit 302a.

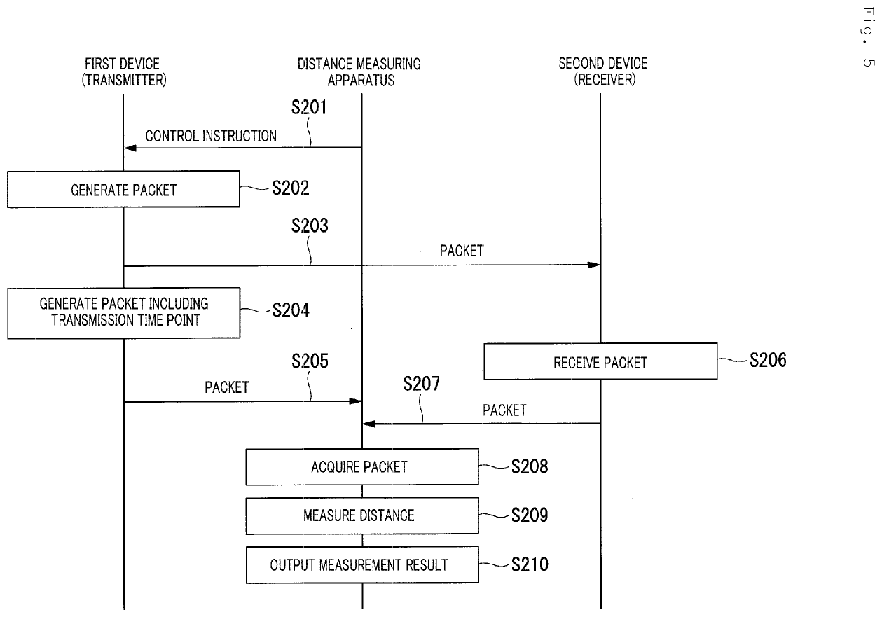

FIG. 5 is a sequence diagram illustrating the flow of processing of the distance measuring system 100 in Embodiment 2.

The output control unit 301a outputs a control instruction including an instruction for causing the packet to be transmitted to the transmitter at a second timing (Step S201). The second timing may be timing at which an instruction for generating a packet is provided from the outside, a timing at which a predetermined period of time passes after the start up, or other timings.

The transmitter acquires the control instruction output from the distance measuring apparatus 30a. The transmitter generates a packet in accordance with the acquired control instruction (Step S202). Then, the transmitter transmits the generated packet to the receiver (Step S203).

The transmitter generates a packet including information on the transmission time point of the packet (Step S204). The transmitter transmits the packet generated in the processing in Step S204 to the distance measuring apparatus 30a (Step S205).

The receiver receives the packet transmitted from the transmitter (Step S206). The receiver acquires the time point at which the packet is received. Then, the receiver generates a packet including the information on the acquired reception time point, and outputs the generated packet to the distance measuring apparatus 30a (Step S207).

The information acquisition unit 302a acquires the packet transmitted from the transmitter and the packet transmitted from the receiver (Step S208). The information acquisition unit 302a outputs the acquired packets to the distance information acquisition unit 303a. The distance information acquisition unit 303a measures the distance on the basis of the packets output from the information acquisition unit 302a (Step S209). Specifically, first, the distance information acquisition unit 303a calculates time Δt required for the transmission and reception of the packets by acquiring the difference between the transmission time point and the reception time point with use of the information on the transmission time point included in the packet acquired from the transmitter and the information on the reception time point included in the packet acquired from the receiver. Next, the distance information acquisition unit 303a calculates a propagation velocity v of the packet through the air. When the distance between the two spots is represented by D2, the distance information acquisition unit 303a measures a distance D2 between the transmitter and the receiver on the basis of Formula 2 below.

[Formula. 2]

D2=v×Δt Formula 2

The distance information acquisition unit 303a outputs information on the distance D2 between the transmitter and the receiver that is the calculation result to the output unit 304. The output unit 304 outputs information on the distance D2 to the external display apparatus (Step S210).

According to the distance measuring system 100 formed as above, the distance between the reference site and the section to be measured is calculated on the basis of the difference in the propagation time, and hence the distance between the plurality of sections during the movement of the person to be measured can be measured in a more convenient manner regardless of the measuring environment, the movement of the person to be measured, and obstacles.

### Modified Example

A configuration in which the transmitter transmits a packet including information on a transmission time point of the packet to the receiver and the receiver transmits the packet including the information on the transmission time point of the packet to the distance measuring apparatus 30a may be employed.

Some of the function units (the output control unit 301a, the information acquisition unit 302a, the distance information acquisition unit 303a, and the output unit 304) included in the distance measuring apparatus 30a may be included in other apparatuses.

The distance information acquisition unit 303a may be formed so as to acquire the distance between the two spots on the basis of a table in which the time Δt necessary for the transmission and the reception of the packet, the propagation velocity v of the packet through the air, and the distance D2 between the two spots are associated with each other.

In this embodiment, a configuration in which the receiver is attached to one section has been described, but a configuration in which receivers are installed in a plurality of sections to be measured may be employed. When such configuration is employed, the distance information acquisition unit 303 determines the packets acquired from the receivers on the basis of identification information of the receivers, and measures the distances between the transmitter and the receivers.

As a result, the distances between the reference site and the plurality of sections to be measured can be simultaneously measured.

The embodiments of the present invention have been described in detail above with reference to the drawings, but the specific configurations are not limited to those embodiments, and designs and the like that do not depart from the gist of the present invention are also included.

### REFERENCE SIGNS LIST

10 First device
20 Second device
30, 30a Distance measuring apparatus
301, 301a Output control unit
302, 302a Information acquisition unit
303, 303a Distance information acquisition unit
304 Output unit

1. A distance measuring apparatus, comprising:
a processor; and
a storage medium having computer program instructions stored thereon, where executed by the processor, perform to:
acquire information output from a second device that is attached to a target site for which a distance between a reference site and the target site is to be measured and acquires sound wave or radio wave output from a first device that is attached to the reference site and outputs sound wave or radio wave and information relating to an output of a first device; and
acquires a distance between the first device and the second device on the basis of the acquired information.

2. The distance measuring apparatus according to claim 1, wherein
the information output from the second device is acquired sound wave information indicating the sound wave output from the first device;
the information relating to the output of the first device is output sound wave information indicating the sound wave output from the first device; and
the computer program instructions further perform to acquire the distance between the first device and the second device on the basis of the acquired sound wave information and the output sound wave information.

3. The distance measuring apparatus according to claim 2, wherein the computer program instructions further perform to acquire the distance between the first device and the second device on the basis of a phase difference between a waveform of sound indicated by the acquired sound wave information and a waveform of sound indicated by the output sound wave information.

4. The distance measuring apparatus according to claim 1, wherein
the information output from the second device is acquisition time point information indicating a time point at which the radio wave output from the first device is acquired;
the information relating to the output of the first device is output time point information indicating a time point at which the first device outputs the sound wave or the radio wave; and
the computer program instructions further perform to acquire the distance between the first device and the second device on the basis of the acquisition time point information and the output time point information.

5. The distance measuring apparatus according to claim 4, wherein the computer program instructions further perform to acquire the distance between the first device and the second device on the basis of a time difference between a time point indicated by the acquisition time point information and a time point indicated by the output time point information.

6. A distance measuring system, comprising:
a first device that is to be attached to a reference site and outputs sound wave or radio wave;
a second device that is to be attached to a target site for which a distance between the reference site and the target site is to be measured and acquires the sound wave or the radio wave output from the first device; and
a distance measuring apparatus including a processor; and a storage medium having computer program instructions stored thereon, where executed by the processor, perform to:
acquires information output from the second device and information relating to the output of the first device; and
acquires a distance between the first device and the second device on the basis of the acquired information.

7. A distance measuring method, comprising:
an information acquisition step of acquiring information output from a second device that is attached to a target site for which a distance between a reference site and the target site is to be measured and acquires sound wave or radio wave output from a first device that is attached to the reference site and outputs sound wave or radio wave and information relating to an output of a first device; and
a distance acquisition step of acquiring a distance between the first device and the second device on the basis of the acquired information.
